(19) United States
(12) Patent Application Publication
(10) Pub. No.: US 2003/0168146 A1
(43) Pub. Date: Sep. 11, 2003

(54) Nonwoven material and method of producing the same

(76) Inventors: David E. Wenstrup, Easley, SC (US); Don A. Lovinggood, Simpsonville, SC (US)

Correspondence Address: Jeffery E. Bacon, Legal Department, M-495, PO Box 1926, Spartanburg, SC, 29304, US

(21) Appl. No.: 10/328,752

(22) Filed: Dec. 23, 2002

Related U.S. Application Data
(63) Continuation of application No. 09/655,118, filed on Sep. 5, 2000, now abandoned.

(51) Int. Cl. B32B 31/20; B32B 5/00

(52) U.S. Cl. 156/62.2; 156/296; 156/309.6; 442/411

(57) ABSTRACT

A nonwoven web having first fibers and second fibers oriented generally perpendicular to the planar direction of the web. The first fibers are standard polyester staple fibers and the second fibers are staple fibers of a blend of polyester material having a melt temperature below the material of the first fibers and above the mold temperature of a subsequent molding process.

### FIELD OF INVENTION

The present invention relates to a nonwoven material, and in particular, to a nonwoven material that can be used for replacement of foam for the backing of materials, and the method of producing the same.

### BACKGROUND

Polyurethane foams are often used as fabric backings for vehicle interior materials in the transportation industry. Typically these foams are adhered to the backs of textile face materials of polyester, vinyl, or leather. The polyester materials are typically of a knit, woven, or nonwoven construction.

These foam backed composites have a cushion affect which can offer comfort or a luxurious feel in contact areas, and allow engineering tolerances in final assembly at component interfaces. Additionally these properties can be maintained in typical automotive construction processes which might include but are not limited to molding and contouring.

Nevertheless, there are several disadvantages to using polyurethane foam as a backing on polyester materials. First the composite product consisting of two dissimilar materials is difficult to separate into its individual entities and therefore is difficult to recycle. Second, the polyurethane foam backed material can emit a high number of volatile materials which contribute to ‘fogging’ of automotive interiors, and the foam itself will oxidize over time leading to a color change in the material. Because of these disadvantages, the automotive industry has continued to look for another material that would provide the cushion properties of polyurethane foam at similar costs.

One material which has received attention in this regard is polyester nonwovens. These materials can provide a suitable backing to most polyester face fabrics and can be made into a composite material with industry recognized techniques. To date, however, in order to obtain cushions of similar thickness to those currently being used with polyurethane foams, an economically deficient amount of material was required.

Recent technologies of perpendicular laid, thermally bonded nonwovens, including air laid and “Struto” nonwoven techniques, have strived to provide this cushion with an economical and weight advantage to previous nonwoven technologies. These techniques orient the staple fibers into a vertical position and allow increased material thickness without the increased material usage. While these techniques have been successful in obtaining increased composite thicknesses at reasonable weights and cost, the structural integrity of the present resulting product has been unacceptable for many automotive interior uses without the incorporation of a bicomponent crosslinking fiber. The use of these crosslinking fibers has heretofore caused problems in many downstream processes due to reorientation and stiffness from the fibers when heated in downstream processes such as molding or contouring.

### BRIEF DESCRIPTION OF THE DRAWINGS

FIG. 1 is a cross-sectional view of an embodiment of the present invention, illustrating the vertical orientation and crosslinking of the fibers for structural stability.

FIG. 2 is a block diagram illustrating one embodiment of a method for forming the nonwoven web from FIG. 1.

### DETAILED DESCRIPTION

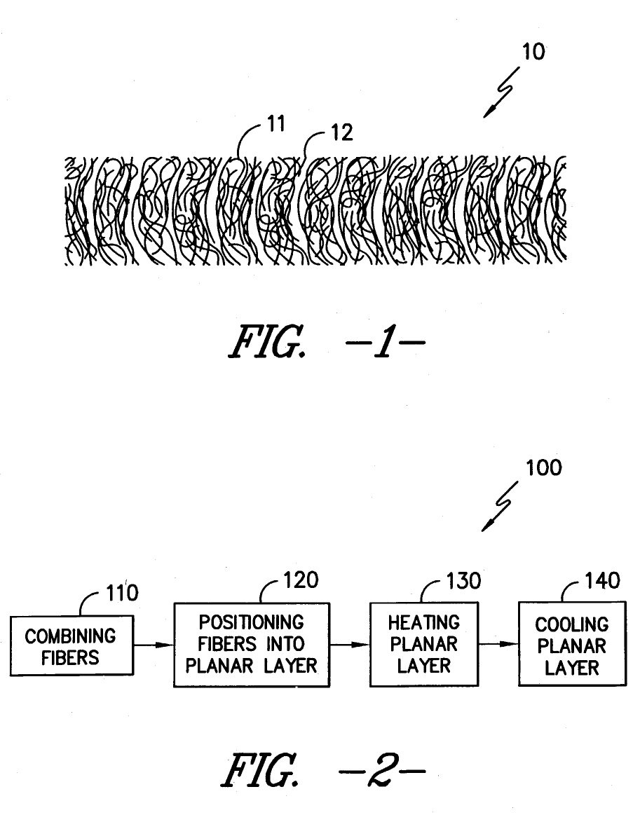

Referring now to FIG. 1, there is shown an embodiment of the present invention, shown as a nonwoven web 10. The nonwoven web 10 generally includes first fibers 11 and second fibers 12. The first fibers 11 comprise from about 30% to about 90% by weight of the nonwoven material 10, and the second fibers comprise from about 10% to about 70% by weight of the nonwoven material 10. In one embodiment, the first fibers 11 comprise from about 70% to about 90% by weight of the nonwoven material 10, and the second fibers comprise from about 10% to about 30% by weight of the nonwoven material 10. In yet another embodiment, the first fibers 11 comprise about 80% by weight of the nonwoven material 10, and the second fibers comprise about 20% by weight of the nonwoven material 10.

The first fibers 11 are typically staple polyester fibers formed of standard polyester staple fibers of between about 1 and about 18 denier per filament. In one embodiment, the first fibers 11 have a denier per filament of about 6 or about 15, depending on the application or desired final qualities of the nonwoven web 10. In yet another embodiment, all or a portion of, the first fibers 11 are of hollow-fil makeup to impart additional cushion to the nonwoven web 10. It is also contemplated that the first fibers 11 can be a blend of different fibers formed from different materials.

The second fibers 12 are formed of a material having a lower melting point than the material of the first fibers 11. Also, the second fibers 12 have a melting point above the mold temperature that the nonwoven web 10 will experience in a subsequent molding process. In one embodiment where the first fibers 11 are staple polyester fibers formed of standard polyester, the second fibers 12 can be staple polyester fibers formed of blend such as a blend of an aliphatic group with polyester. In another embodiment, the second fibers 12 can be a multi-component, such as a core and sheath fiber, with one of the components (such as the sheath) having a melt temperature lower than the material of the first fibers 11. It is also contemplated that the second fibers 12 can be a blend of different fibers formed from different materials. The second fibers 12 are typically staple fibers of between about 1 and about 18 denier per filament. In one embodiment, the second fibers 12 have a denier per filament of about 3.

The first fibers 11 and the second fibers 12 are oriented between about 45° and about 90° from the planar direction of the nonwoven web 10. In a preferred embodiment, the first fibers 11 and the second fibers 12 are oriented generally perpendicular to the planar direction of the nonwoven web 10. The nonwoven web 10 is stabilized due to the fusing of various second fibers 12 with first fibers 11.

The nonwoven web 10 is of the type that can be used as a backing for materials such as textile face materials. The nonwoven material 10 can be molded in a subsequent process at a mold temperature below the melt temperature of the second fibers 12, without substantial degradation of the resilience of the nonwoven material 10. When the first fibers 11 and the second fibers 12 of the nonwoven web 10 are both polyester, the nonwoven web 10 is more readily recyclable.

In one embodiment, the nonwoven web 10 has a thickness of from about 2 mm to about 20 mm and a density of from about 50 g/m² to about 800 g/m². In an embodiment for use in a panel application such as automotive headliners, the nonwoven web 10 can have a thickness of from about 2 mm to about 5 mm, and a density of from about 50 g/m² to about 200 g/m². In an embodiment for use in a cushion application such as upholstry, the nonwoven web 10 can have a thickness for from about 3 mm to about 15 mm, and a density of from about 100 g/m² to about 500 g/m².

A method of forming the nonwoven web 10 of FIG. 1 is illustrated in FIG. 2 as the process 100. The process 100 generally includes the steps of combining fibers 110, positioning the combined fibers into a layer 120, heating the layer 130, and cooling the layer 140.

The step of combining fibers 110, includes combining first fibers 11 and second fibers 12. The first fibers 11 have a higher melting point than the second fibers 12. Additionally, the second fibers 12 have a melting point higher than the mold temperature of a subsequent molding process. In one embodiment, the first fibers 11 are formed of a standard polyester, and the second fibers 12 are formed of a lower melt temperature polyester, such as a blend of an aliphatic group and polyester. The first fibers 11 and the second fibers 12 are combined in a ratio such that the first fibers 11 comprise from about 30% to about 90% by weight of the nonwoven material 10, and the second fibers comprise from about 10% to about 70% by weight of the nonwoven material 10. In one embodiment, the first fibers 11 comprise from about 70% to about 90% by weight of the nonwoven material 10, and the second fibers comprise from about 10% to about 30% by weight of the nonwoven material 10. In yet another embodiment, the first fibers 11 comprise about 80% by weight of the nonwoven material 10, and the second fibers comprise about 20% by weight of the nonwoven material 10. The first fibers 11 and the second fibers 12 are between about 1 and about 18 denier. In one embodiment, the first fibers 11 have a denier per filament of about 6 or about 15, depending on the application or desired final qualities of the nonwoven web 10, and the second fibers 12 have a denier per filament of about 3. Additionally, all, or a portion of, the first fibers 11 can be of a hollow-fil makeup to impart additional cushion in the nonwoven web 10.

In the positioning step 120, the combined first fibers 11 and second fibers 12 are positioned into a planar layer by “Struto” nonwoven techniques, air laying, or the like. “Struto” nonwoven techniques is the method of forming a nonwoven web from a carded web of fibers. The carded web descends vertically with the fibers oriented vertically, and is positioned at the nonwoven web by a vertical blade. Positioning of the carded web by the vertical web causes the carded web to fold over in the nonwoven web in an accordion-like fashion. After the vertical blade has positioned the carded web in the nonwoven web, a horizontal blade with pins oriented horizontally, packs the carded web into the nonwoven web. After the carded web is packed into the nonwoven web, the nonwoven web is heat set.

The step of combining 110 the first fibers 11 with the second fibers 12 can be performed simultaneously with the step of positioning 120 the fibers into a planar layer. The first fibers 11 and second fibers 12 are positioned in the planar layer such that the first fibers 11 and the second fibers 12 are oriented between about 45° and about 90° from the planar direction of the planar layer. In one embodiment, the first fibers 11 and the second fibers 12 are positioned perpendicular to the planar layer. The combination of the first fibers 11 and the second fibers 12 are positioned into the planar layer at a density of from about 50 g/m² to about 800 g/m², and the thickness of the planar layer is from about 2 mm to about 60 mm.

After the first fibers 11 and the second fibers 12 are positioned into the planar layer, the planar layer is heated to a temperature above the melting point of the second fibers 12 in the heating step 130. The heating step causes the second fibers 12 to fuse with the first fibers 11. Preferably, the planar layer is not heated above the melting point of the first fibers 11. When the first fibers 11 are formed of a standard polyester, the temperature of the heating step 130 typically does not exceed 270° C. In an embodiment where the first fibers 11 are formed of standard polyester, and the second fibers 12 are formed of a blend such as a blend of an aliphatic group and polyester, the planar layer is heated to a temperature between about 115° C. and about 260° C., and preferably between about 160° C. and about 200° C.

After the planar layer is heated to fuse the second fibers 12 with the first fibers 11, the planar layer is cooled in the cooling step 140 to a temperature below the melting point of the second fibers 12, thereby forming the nonwoven web 10.

A nonwoven web 10 formed from the process 100 with a polyester material, will typically permit a molding operation using a temperature between about 115° C. and about 220° C., and retain the ability to return to its orignial thickness. In one embodiment, the nonwoven web 10 will retain the ability to return to its original thickness after being subjected to a molding process with a mold temperature from about 140° C. to about 170° C.

In one example of the present invention, a nonwoven web was formed from first fibers being a blend of KOSA T-209 and T-210 polyester fibers, and second fibers of a KOSA T-252 polyester. The first fibers are a blend of 50% by total weight of the T-209 polyester staple fibers with a size of 6 denier per filament, and 50% by total weight of the T-210 polyester staple with a size of 15 denier per filament. The second fibers are the T-252 polyester staple fibers with a size of 3 denier per filament. The first fibers and the second fibers are combined with a ratio of 80% of total weight the first fibers and 20% by total weight of the second fibers. The combined first and second fibers are positioned into a planar layer using the Struto nonwoven techniques to position the first and second fibers in a generally perpendicular direction to the planar layer. The planar layer of first and second fibers is about 12 mm thick and has a density of about 450 g/m². The planar layer of first and second fibers is heat set at a temperature of about 205° C., and then cooled to form a nonwoven web of the present invention. The nonwoven web formed in this example can also be split into three separate webs each being about 3 mm thick.

What is claimed is:

1. A nonwoven material for use in a molding process having a mold temperature, said nonwoven comprising:
a plurality of first fibers having a first fiber melt temperature, the first melt temperature being greater than the mold temperature;
a plurality of second fibers having a second fiber melt temperature being lower than the first fiber melt temperature of said first fibers and greater than the mold temperature;
wherein said first fibers and said second fibers are bonded together into a web having a planar direction, the first fibers and the second fibers being substantially oriented between about 45° and about 90° from the planar direction of the web.

2. The nonwoven material according to claim 1, wherein said first fibers comprise from about 30% to about 90% of the total weight of the nonwoven material.

3. The nonwoven material according to claim 1, wherein said first fibers comprise from about 70% to about 90% of the total weight of the nonwoven material.

4. The nonwoven material according to claim 1, wherein said first fibers comprise about 80% of the total weight of the nonwoven material.

5. The nonwoven material according to claim 1, wherein said nonwoven material is a planar material with a planar direction, and wherein said first fibers and said second fibers are substantially perpendicular to the planar direction of the nonwoven material.

6. The nonwoven material according to claim 1, wherein said first fibers and said second fibers are both a polyester based material.

7. The nonwoven material according to claim 6, wherein the second fibers are a blend of an aliphatic group and polyester.

8. The nonwoven material according to claim 1, wherein said first fibers and said second fibers are between about 1 denier per filament and about 18 denier per filament.

9. The nonwoven material according to claim 1, wherein said first fibers are about 6 denier per filament.

10. The nonwoven material according to claim 1, wherein said first fibers are about 15 denier per filament.

11. The nonwoven material according to claim 1, wherein said first fibers are hollow.

12. The nonwoven material according to claim 1, wherein said first fibers are a blend of different fibers formed from different materials.

13. The nonwoven material according to claim 1, wherein said second fibers are about 3 denier per filament.

14. The nonwoven material according to claim 1, wherein the second fibers are a multicomponent fiber, with at least one of the components being the portion of the second fiber having the second melt temperature.

15. The nonwoven material according to claim 14, wherein said second fibers have a core and a sheath, and wherein the component of the second fibers having the second melt temperature is the sheath.

16. The nonwoven material according to claim 1, wherein said second fibers are a blend of different fibers formed from different materials.

17. The nonwoven material according to claim 1, wherein the nonwoven material has a thickness of from about 2 mm to about 20 mm.

18. The nonwoven material according to claim 1, wherein the nonwoven material has a thickness of from about 2 mm to about 5 mm.

19. The nonwoven material according to claim 1, wherein the nonwoven material has a thickness of from about 5 mm to about 15 mm.

20. The nonwoven material according to claim 1, wherein the nonwoven material has a density of from about 50 g/m² to about 800 g/m².

21. The nonwoven material according to claim 1, wherein the nonwoven material has a density of from about 50 g/m² to about 200 g m².

22. The nonwoven material according to claim 1, wherein the nonwoven material has a density of from about 100 g/m² to about 500 g/m².

23. A nonwoven material comprising:
a plurality of first fibers and a plurality of second fibers, the second fibers having a second fiber melt temperature between about 115° C. and about 220° C., and the first fibers having a first fiber melt temperature greater than the second fiber melt temperature;
wherein said first fibers and said second fibers are bonded together into a web having a planar direction, the first fibers and the second fibers being substantially oriented between about 45° and about 90° from the planar direction of the web.

24. The nonwoven material according to claim 23, wherein said first fibers comprise from about 30% to about 90% of the total weight of the nonwoven material.

25. The nonwoven material according to claim 23, wherein said first fibers comprise from about 70% to about 90% of the total weight of the nonwoven material.

26. The nonwoven material according to claim 23, wherein said first fibers comprise about 80% of the total weight of the nonwoven material.

27. The nonwoven material according to claim 23, wherein said nonwoven material is a planar material with a planar direction, and wherein said first fibers and said second fibers are substantially perpendicular to the planar direction of the nonwoven material.

28. The nonwoven material according to claim 23, wherein said first fibers and said second fibers are both a polyester based material.

29. The nonwoven material according to claim 28, wherein the second fibers are a blend of an aliphatic group and polyester.

30. The nonwoven material according to claim 23, wherein said first fibers and said second fibers are between about 1 denier per filament and about 18 denier per filament.

31. The nonwoven material according to claim 23, wherein said first fibers are about 6 denier per filament.

32. The nonwoven material according to claim 23, wherein said first fibers are about 15 denier per filament.

33. The nonwoven material according to claim 23, wherein said first fibers are hollow.

34. The nonwoven material according to claim 23, wherein said first fibers are a blend of different fibers formed from different materials.

35. The nonwoven material according to claim 23, wherein said second fibers are about 3 denier per filament.

36. The nonwoven material according to claim 23, wherein the second fibers are a multicomponent fiber, with at least one of the components being the portion of the second fiber having the second melt temperature.

37. The nonwoven material according to claim 36, wherein said second fibers have a core and a sheath, and wherein the component of the second fibers having the second melt temperature is the sheath.

38. The nonwoven material according to claim 23, wherein said second fibers are a blend of different fibers formed from different materials.

39. The nonwoven material according to claim 23, wherein the nonwoven material has a thickness of from about 2 mm to about 20 mm.

40. The nonwoven material according to claim 23, wherein the nonwoven material has a thickness of from about 2 mm to about 5 mm.

41. The nonwoven material according to claim 23, wherein the nonwoven material has a thickness of from about 5 mm to about 15 mm.

42. The nonwoven material according to claim 23, wherein the nonwoven material has a density of from about 50 g/m² to about 800 g/m².

43. The nonwoven material according to claim 23, wherein the nonwoven material has a density of from about 50 g/m² to about 200 g/m².

44. The nonwoven material according to claim 23, wherein the nonwoven material has a density of from about 100 g/m² to about 500 g/m².

45. A method of forming a nonwoven composite, comprising the steps of:
a) combining a plurality of first fibers, having a first melt temperature, with a plurality of second fibers, having a second fiber melt temperature being lower than the first fiber melt temperature
b) orienting the first fibers and the second fibers into a planar layer with a substantial portion of said first fibers and said second fibers being between about 45° and about 90° from the planar direction of the planar layer;
c) heating the planar layer of first fibers and second fibers to a temperature above the second fiber melt temperature of the second fibers and then cooling the planar layer below the second melt temperature, thereby bonding the first fibers and the second fibers together to form a web of nonwoven material; and
d) cooling the planar layer of nonwoven material.

46. The method according to claim 45, wherein said step of orienting the first fibers and the second fibers includes air laying the first fibers and the second fibers into the planar layer.

47. The method according to claim 45, wherein said step of orienting the first fibers and the second fibers includes forming the planar layer with Struto nonwoven formation.

48. The method according to claim 45, wherein the first fibers and the second fibers are polyester based material.

49. The method according to claim 48, wherein said step of heating the planar layer includes heating said planar to a temperature between about 115° C. and about 260° C.

50. The method according to claim 48, wherein said step of heating the planar layer includes heating said planar to a temperature between about 160° C. and about 200° C.
